(19) United States
(12) Patent Application Publication
(10) Pub. No.: US 2005/0187876 A1
(43) Pub. Date: Aug. 25, 2005

(54) System for cash handling

(75) Inventor: Hermann Gessler, Munich (DE)

Correspondence Address: ROTHWELL, FIGG, ERNST & MANBECK, P.C., 1425 K STREET, N.W., SUITE 800, WASHINGTON, DC, 20005, US

(73) Assignee: GIESECKE & DEVRIENT GmbH, Munich (DE)

(21) Appl. No.: 11/054,609

(22) Filed: Feb. 10, 2005

(30) Foreign Application Priority Data
Feb. 10, 2004 (DE) 10 2004 006 432.2

(51) Int. Cl. G06F 17/60

(52) U.S. Cl. 705/42; 705/43

(57) ABSTRACT

A system for the processing of orders for cash handling, wherein a central entity by a central computer via data lines can exchange data with different institutions, in particular with one or more commercial banks, one or more central banks and one or more cash centers, and wherein the central computer in dependence on customer-specific order data produces processing data, which are forwarded to at least a part of the institutions via the data lines for processing the order of the customer. This system permits an effective automated processing of most different operations for cash handling in the money circuit.

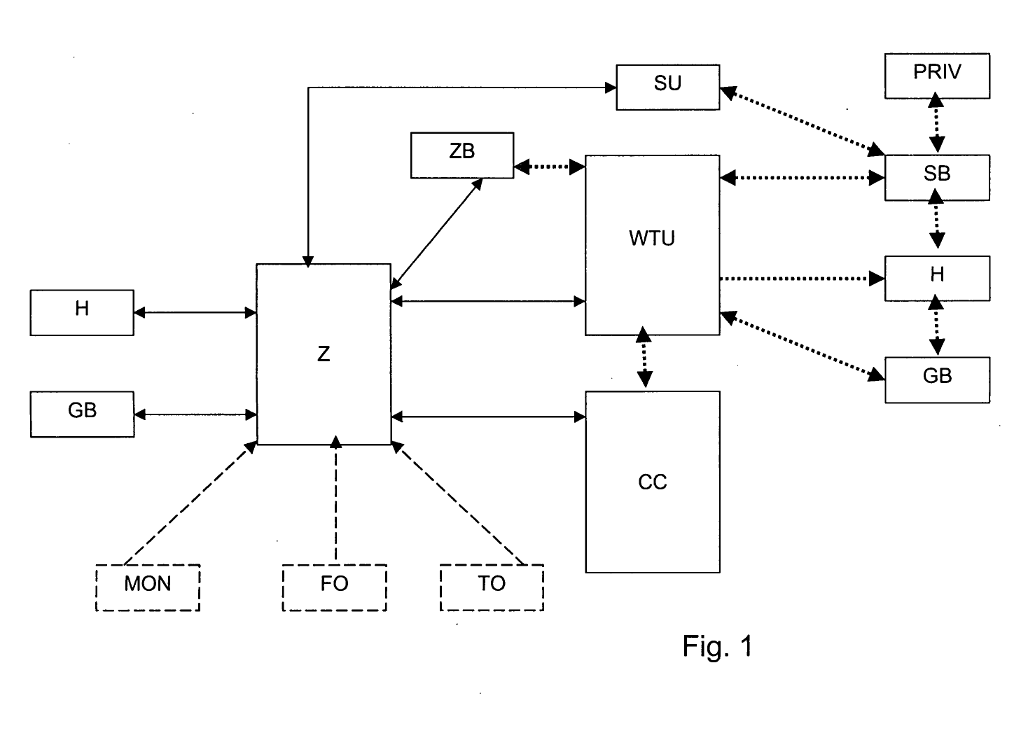

### BACKGROUND OF THE INVENTION

1. Field of the Invention

The invention relates to a system for the handling of cash, such as bank notes or coins.

2. Description of the Background Art

In the following in particular the problem of handling bank notes is dealt with. There are different institutions, which handle bank notes in larger quantities. These are on the one hand the central banks acting on behalf of the government and usually responsible for the production and issue of new bank notes, the check of bank notes already circulated and the destruction of bank notes checked to be no longer fit for circulation. For checking usually bank-note sorting apparatuses are used, in which the bank notes are checked with high accuracy and speed as to authenticity and fitness for circulation. Further institutions are commercial banks. These pay out cash to their business or private customers or receive cash from them, so as to credit it to their bank accounts. Partially, automatic teller machines are used in this connection for paying in and/or out. Furthermore, there are so-called cash centers, which carry out a checking and packaging of delivered cash holdings on behalf of central banks or commercial banks. Secure carriers are responsible for the transportation of the cash holdings between the individual institutions. In addition, commercial banks more and more entrust independent service providers with the technical maintenance of their automatic teller machines.

As to facilitate the working processes in the different areas of the money circuit, the most institutions now use software solutions, so as to automate their flow of work. Solutions concerning the area of filling automatic teller machines are described, for example, in WO 00/26873 A1 or WO 01/97129 A1. According to these solutions an information center is supplied with data coming from individual automatic teller machines, these data being used that the machines are timely emptied or filled with new money.

For example from EP 0 653 717 B1 it is further known, that a central computer via a data line can be connected to several automatic teller machines for transferring transaction data. The central computer for example serves for carrying out a balancing of accounts regarding the amounts paid in or out at the automatic teller machines.

However, these systems have the disadvantage, that they facilitate only individual aspects of cash handling.

### SUMMARY OF THE INVENTION

On these premises, it is the problem of the present invention to provide a system for cash handling, which permits a more effective cash handling.

The invention is based on the idea to install a central entity, which is able to get in data communication with all institutions relevant for money circulation, i.e. in particular with commercial banks, central banks and cash centers, and to automatically produce processing data for processing orders of customers and forward these data to the respective institutions. By the central entity being connected to all named institutions, most of the commonly occurring orders regarding the handling of larger cash holdings can be carried out half-automatically or fully automatically. Because of this the inventive system not only permits to efficiently carry out a filling and emptying of automatic teller machines, but also other operations for cash handling in the money circuit, such as the transport of cash between commercial banks, cash centers and central banks.

This is an essential advantage in contrast to the prior art computer-aided systems e.g. according to WO 00/26873 A1 or WO 01/97129 A1, which each cover only individual aspects of this money circuit.

For this a central computer of the central entity is especially preferred, i.e. preferably the software running in the central computer, which at least has a part or all of the following modules: an order recording module for recording and saving order data of the order of the customer, a calculating module for calculating processing data on the basis of the order data and for allocating processing data to at least a part of the institutions, a data transmission module for transmitting data such as processing data to the appropriate institutions, an acknowledgement data recording module for recording acknowledgement data related to the order data and/or processing data, which are transferred to the central computer by the institutions, a monitoring module for checking the plausibility of order data and/or processing data and/or acknowledgement data, an accounting module for generating customer-related invoice data and/or accounting data, which are obtained on the basis of the order data, processing data and/or acknowledgement data.

The provision of all these modules permits to automatically carry out, monitor and account for the order processing.

Furthermore, the problem is solved by a data carrier with a software, which is designed to realize the inventive system. The software on the data carrier in particular will have the above-mentioned modules, i.e. order recording module, calculating module, data transmission module, acknowledgement data recording module, monitoring module and/or accounting module.

It shall be emphasized, that the features of the dependent claims and the embodiments named in the following description, in combination or independently of each other and of the subject matter of the main claims, describe further basic ideas and can be advantageously used, e.g. even then, when not all of the institutions relevant for money circulation, i.e. in particular the commercial banks, central banks and cash centers, and the central entity, are connected to each other.

### BRIEF DESCRIPTION OF THE DRAWING

Further advantages of the present invention are explained in detail in the following with reference to the only drawing attached. The FIGURE schematically shows the data transfer illustrated by continuous lines and the cash transportation illustrated by dotted lines between different institutions of the money circuit symbolized by boxes in an inventive system for cash handling according to a first embodiment.

### DETAILED DESCRIPTION OF THE INVENTION

The purpose of the inventive system for cash handling is to provide a central processing of orders involving most of the cash handling processes usual in the money circuit. One essential unit in the inventive system for cash handling, which is schematically illustrated in the only FIGURE, is the central entity Z. In the central entity Z for this purpose a central computer is used, which can consist of one or more computer modules networked to each other and has interfaces, so as to automatically exchange data with other institutions of the money circuit. These institutions in particular are branches of commercial banks GB, central banks ZB, secure carriers WTU, cash centers CC and service providers SU taking on the maintenance and other services for automatic teller machines SB. However, it can also be provided, that the central entity Z e.g. is a part of the cash center CC.

As data lines between these individual institutions, which in the FIGURE are symbolically illustrated by continuous lines, preferably standardized interfaces are used, such as Internet-, or email-, remote-data-transmission-, SMS- or fax-based connections. Especially preferred are such data lines, such as Internet- or remote-data-transmission-connections, which permit a fully automatic data transfer between the central computer and a computer of the institutions connected by the data line.

The central computer or the software installed thereon in particular is able to record several orders even of different customers, to automatedly produce respective processing data for carrying out these orders, to forward the pertinent information to all institutions connected via data lines, and to monitor the proper carrying out of the orders by means of the acknowledgements given by these institutions. In addition, an accounting with the individual institutions involved regarding the services rendered by them in connection with the order processing and a preparation of invoice data and/or accounting entries for the customer are automatically carried out, the invoices or entries being prepared on the basis of the order data, calculating data and acknowledged data of the institutions entrusted with the carrying out of the execution of the order. By inventively creating a central entity Z for the coordination of the named operations, an automated and standardized solution is provided, so as to be able to realize a central cash logistic.

The details of typical processes in order processing according to the inventive system for cash handling can be arranged as follows.

1. Kinds of Orders:

There are different kinds of orders, which relate to cash handling and can be dealt with by the central entity Z. Examples may be orders for cash supply or cash disposal, i.e. orders of commercial banks GB or wholesalers H to deliver to or collect certain cash holdings at these customers at certain points of time.

For example, a trader H or a branch of a commercial bank GB can place an order with, for example, the central entity Z, that the daily balance money is collected or the change for the next day is delivered.

Furthermore, services are also possible, such as orders of commercial banks GB that a secure carrier WTU at certain points of time fills and empties their automatic teller machines SB, which are used by private individuals PP for paying out and/or depositing of cash, or that service providers SU carry out maintenance services at such automatic teller machines SB.

2. Recording of Order Data:

The customer, e.g. a branch of a commercial bank GB, transfers these order data to an order recording module of the central computer of the central entity Z, preferably via a standardized interface. According to an independent idea of the present invention, the system of the central entity Z is of such a design that the customer GB can send the data to the central computer of the central entity Z via different interfaces, such as e.g. via an Internet connection as well as via a fax connection or another customer-specific interface.

In case the customer transfers his order to the central entity Z via fax, there can be provided, for example, that the fax is scanned with the aid of an OCR (Optical Character Recognition) reader and the relevant order data are extracted automatically and supplied in electronic form to the central computer. If necessary, an operator in the central entity Z may correct the fax, in case the OCR-reading was not successful.

Here such data transmission methods are preferred, which permit a fully automatic recording of the order data in the software of the central computer of the central entity Z without interposition of manual activities, such as e.g. an order data transmission by means of the Internet or remote-data-transmission-connection. In case e.g. the Internet is used, the sending of orders can be carried out with the aid of HTML forms or the like, in the preset electronic forms of which the authorized customer can enter his order data.

It is also possible, that order data are generated automatically by the order recording module on the basis of customer specifications. In this way e.g. periodic maintenance orders can be generated, which are transferred to a service provider SU, so that said service provider can perform maintenance work (repairs, replenishing of printer paper and printer ink etc.) at automatic teller machines SB after the termination of an operation period, which, optionally, is specifically determined for the automatic teller machine SB.

3. Checking of Order Data:

For the order data transmission a mechanism for authentication can be provided. Such an authentication can be effected e.g. by a transmission of encrypted data, for which only the respective customer has a specific digital key for data transmission at its disposal, which is not available to not authorized third parties. By this means there can be ensured, that only entitled customers can send orders to the central entity Z.

In case of an order transmission via FAX, there may exist, for example, a list of the persons authorized to order on behalf of a customer, and an automatic comparison of the fax signature recorded in electronic form by an image analysis software with the saved signature sample can be carried out, so as to verify the authorization for ordering.

These checks are carried out in a monitoring module of the central computer Z, which e.g. further checks the order data as to logical consistency, the financial soundness of the customer etc. Specifically, e.g. the customer structure can be checked by controlling, whether a customer is already part of a customer master data management system, i.e. whether this system is complete or not. Additionally, there can be checked, whether data records were created twice, because e.g. the same order data were sent by the Internet as well as by fax to the central entity.

After the order data being electronically recorded in the central computer, e.g. according to the named fashions, advantageously by means of a data transmission module the customer is sent a confirmation of order or, as the case may be, a rejection of the order, e.g. in case the monitoring module has detected discrepancies. This information can be transferred via the same or a different data line. Alternatively or additionally, there can exist the possibility, that the customer can retrieve the current status of his order at any time via one of the existing data lines, such as e.g. via the Internet.

4. Generation of Processing Data:

Starting out from the saved order data, in a calculating module of the central computer processing data are automatically produced, which are automatically forwarded at least to a part of the connected institutions, so as to have processed the incoming orders.

In case a branch of a commercial bank GB orders cash holdings, for example processing data are generated, which specify, which cash holdings have to be delivered by which secure carrier WTU at what time to the branch specified by the customer. The selection of the respective institutions, namely to which institution the processing data for carrying out the orders are forwarded, can depend on certain criteria, such as customer-specific selection criteria, kind of previous order data etc. A join operation regarding the locations of the places of business of the secure carriers WTU and the locations of the customers can also be employed as to generate an automatic distribution of the orders to the individual institutions connected, which results in transportation ways as short as possible.

The calculating module is adapted to bundle several orders even of different customers at the same time and to produce joint processing data thereof, which are passed on to the institutions. I.e. that, preferably, the processing data are generated in dependence on several order data, so as to determine e.g. a suitable distribution of the orders to the individual cash centers or WTUs out of several cash centers or WTUs etc.

As symbolically illustrated in the FIGURE by the dashed boxes, the central computer of the central entity Z can take into account results of other software programs when generating order data and in particular when generating processing data.

This can be e.g. a monitoring software MON for automatic teller machines SB, which provides data on filling and state of automatic teller machines SB of customers, a forecast software FO, which on the basis of earlier experience data carries out, for example, calculations, which cash holdings in which cash centers CC, commercial banks GB or automatic teller machines SB are to be expected in the future, or a route planning software TS, which for the secure carrier WTU carries out a suitable route planning in dependence on the processing data produced earlier and/or to be produced.

If a trader H as a customer sends an order for e.g. collecting the daily takings to a cash center CC, which functions as a central entity Z, then in the central computer are generated e.g. data, which are transferred to a secure carrier WTU, so as to entrust this secure carrier with the collecting of the daily takings at the customer H and to transport them to the cash center CC or directly to the central bank ZB for checking the value and authenticity of the bank notes contained in the daily takings.

5. Transmission of Processing Data:

The processing data generated in this way then preferably by means of email or the Internet are passed on to the respective institution, such as in the named case to one specific of the several possible secure carriers WTU. The institutions, which have received processing data, usually confirm that they accept the processing according to the supplied processing data. These data are recorded in a data recording module and checked in the monitoring module as to plausibility.

6. Generation of Accounting Data:

One particularity of the central computer or its software is, that in an accounting module on the basis of the order data and/or the processing data, which are forwarded to the institutions, and/or the acknowledgement data, invoice data and/or accounting data are generated, which are used for both accounting with the entrusted institutions and accounting with the customers.

The accounting and/or invoice data generated in the accounting module on the basis of order data, processing data and data acknowledged by the institutions involved, preferably are transferred to the institutions involved via standardized interfaces in an automatic fashion. If existing, the accounting data are automatically transferred by means of a standardized interface, such as a so-called data carrier exchange interface, to the computer-based accounting systems of the customers. I.e. an automatic accounting entry can be made, without having to take manual actions. The accounting logic for automatically generating the accounting entries here can be configured in a customer-specific fashion.

Preferably, the accounting data or invoice data of the customers and/or institutions involved are generated and/or sent to these at predetermined customer-specific points of time. Furthermore, there can be provided, that the accounting data or the pertinent invoice data are not only forwarded to the customer at predetermined points of time, e.g. in connection with a service rendered by processing an order, but also in a periodic fashion.

In the above-mentioned case of collecting the daily takings of a trader H, for example, detailed information for the commercial bank GB responsible for the trader H is generated, which the commercial bank GB can use for making an entry in the account of the trader H regarding the daily takings collected at the cash center.

A further possibility is, that e.g. after a check of the daily takings collected at the customer the central bank ZB determines deviations, because in the daily takings e.g. forged money was contained. So as to be able to take into consideration these differences when entering the daily takings in the account of the trader H, this information preferably is given to the commercial bank GB responsible for the accounting either by the cash center CC or the checking central bank ZB.

7. Checking of Processing:

Here according to a further advantageous idea, the central computer performs a monitoring of the order processing, i.e. in addition to the above-mentioned check the order data is controlled in the monitoring module, e.g. automatically controlled, whether the passed on processing data were confirmed by the respective institutions and whether the results achieved by these institutions in carrying out the processing orders were transferred or confirmed in the expected time.

For this purpose the monitoring module of the central computer evaluates the carrying out of the order processing in dependence on preset quality factors automatically and specifically for a customer and/or the institutions involved. This can be arranged for example in such a way, that when the institutions involved carry out the order in due time according to the processing data without complaints, this will lead to a positive quality assessment.

In addition, a checking as to the presence of required acknowledgements of the institutions supplied with processing data can be performed, which e.g. have to confirm the acceptance of the order as well as the carrying out.

Now, by way of example, a specific example shall be described as to how an order processing e.g. within the framework of the above-mentioned system can be carried out.

A branch bank can automatically forward to a commercial bank GB order data for delivering cash holdings to the branch, for example by means of a standardized remote data transmission interface of the software of the central computer of the central entity Z. The data are recorded by the order recording module, checked by the monitoring module as to consistency etc., and in case of a positive checking a confirmation of order is transmitted back to the customer by means of the remote data transmission interface by the data transmission module. Then on the basis of the order data of this and, optionally, also other orders processing data are automatically generated by the calculating module, which serve for ordering the desired cash holdings with the central bank ZB or with a cash center CC allocated to the customer, and are transferred to these by the data transmission module. At the same time a respective order is supplied to a secure carrier WTU allocated to the customer, the secure carrier collects the cash holdings, which were ordered e.g. with a specific cash center CC and have already been pre-packed there, in dependence on the customer-specific processing data, and delivers these cash holdings to the respective branch of the customer at the points of time predetermined according to the processing data. At least the secure carrier WTU and preferably the cash center CC, too, send acknowledgement data after having carried out their actions according to the processing data by remote data transmission connection or the like to the central entity Z, so as to report on the proper carrying out of the order. Subsequently or even preceding, accounting data for the secure carrier WTU and the cash center CC involved are automatically prepared by means of the accounting module and forwarded to these, and accounting entries are produced, which are transferred to the accounting system of the customer.

The inventive system for cash handling thus permits a comprehensive automatic carrying out and monitoring of operations for processing of orders in the area of cash handling.

1. System for processing of orders for cash handling, wherein a central entity (Z) by means of a central computer via data lines can exchange data with different institutions, one or more commercial banks (GB), one or more central banks (ZB) and one or more cash centers (CC), and wherein the central computer in dependence on customer-specific order data produces processing data, which are forwarded to at least a part of the institutions via the data lines for processing the order of the customer.

2. System according to claim 1, characterized in that the central computer at least has a part or all of the following modules: an order recording module for recording and saving order data of the order of the customer, a calculating module for calculating processing data on the basis of the order data and for allocating processing data to at least a part of the institutions, a data transmission module for transmitting data such as processing data to the appropriate institutions, an acknowledgement data recording module for recording acknowledgement data related to at least one of the order data or processing data, which are transferred to the central computer by the institutions, a monitoring module for checking the plausibility of at least one of order data, processing data or acknowledgement data, an accounting module for generating at least one of customer-related invoice data or accounting data, which are obtained on the basis of at least one of the order data, processing data, or acknowledgement data.

3. System according to claim 1, characterized in that the institutions, furthermore, include at least one of one or more secure carriers (WTU) for transporting cash holdings, or one or more service providers (SU) for maintaining cash processing machines (SB).

4. System according to claim 1, characterized in that the calculating module produces the processing data on the basis of several different order data and also of different customers.

5. System according to claim 1, characterized in that the order data are at least one of supplied to the order recording module via data lines by the customer or the order recording module itself produces the order data.

6. System according to claim 1, characterized in that the forwarding of the processing data from the central computer to the institutions by means of the data transmission module selectively can be triggered manually by a user or triggered automatically by the central computer at predetermined points of time.

7. System according to claim 1, characterized in that all institutions, which have received processing data, subsequently send back acknowledgement data to the central computer.

8. System according to claim 1, characterized in that the central computer only sends data regarding the release for carrying out the order according to the transferred processing data or processing data to be transferred to the institutions by means of the data transmission module, when the data recording module has received acknowledgement data related to at least one of the order data or processing data.

9. System according to claim 1, characterized in that when the institutions after having received the processing data do not transfer pertinent acknowledgement data within a predetermined period of time, this period of time being selected variably in dependence on at least one of the customer or the order data, the calculating module automatically produces at least one of an alarm signal or altered processing data for the orders concerned.

10. System according to claim 1, characterized in that the monitoring module automatically carries out a plausibility check of all transferred order data, processing data and acknowledgement data, so as to be able to monitor the correct order processing.

11. System according to claim 1, characterized in that there exist different kinds of data lines to all or at least to a part of the institutions, via which data can be selectively exchanged with the central computer.

12. System according to claim 1, characterized in that for a kind of data lines there exists a standardized interface, via which all institutions connected to the central computer can exchange data.

13. System according to claim 1, characterized in that the accounting module makes an entry regarding the orders in at least one account of the customer.

14. System according to claim 1, characterized in that the calculating module determines the processing data in dependence on data on the competence of certain institutions as to at least one of certain customers or geographic location of at least one of certain customers or institutions.

15. System according to claim 1, characterized in that the calculating module determines the processing data in dependence on data of cash processing machines (SB), which the institutions use for order processing.

16. Data carrier with a software, which is equipped for realizing the system according to claim 1.

17. The system of claim 1 wherein said institutions comprise at least two of one or more commercial banks (GB), one or more central banks (ZB), or one or more cash centers (CC).

18. The system of claim 5 wherein the order data are in predetermined time intervals.

19. The system of claim 12 wherein the interface comprises an Internet, email, remote data transmission, SMS or fax based interface.

20. The system of claim 15 wherein the data of the cash processing machines (SB) is transferred to the central computer at predetermined points of time.
